(19) United States
(12) Patent Application Publication
(10) Pub. No.: US 2008/0263544 A1
(43) Pub. Date: Oct. 23, 2008

(54) Computer system and communication control method

(76) Inventors: Koji Amano, Yokohama (JP); Takahiro Ohira, Hitachi (JP)

Correspondence Address: MCDERMOTT WILL & EMERY LLP, 600 13TH STREET, N.W., WASHINGTON, DC, 20005-3096, US

(21) Appl. No.: 12/078,655

(22) Filed: Apr. 2, 2008

(30) Foreign Application Priority Data
Apr. 2, 2007 (JP) 2007-096006

(51) Int. Cl. G06F 9/455

(52) U.S. Cl. 718/1

(57) ABSTRACT

A technology is provided, in which pair information of a virtual machine and a real machine on which the virtual machine operates are made related with each other, and are recorded into a shared memory partition of the virtual machine and a control function of virtual machine infrastructure, from the above-described recorded information, a judgment is made as to whether or not a communication-destination virtual machine exists on the same real machine as that of a communication-source virtual machine, and a technology for changing the multiplicity degree in accordance with this judgment, moreover, the above-described recorded information is written when the virtual machine has displaced to another real machine to implement a reduction in the CPU usage ratio in network processing between the operating virtual machines, and to dynamically control the multiplicity degree of the communication path by making full use of location information between the virtual machines.

### INCORPORATION BY REFERENCE

The present application claims priority from Japanese application JP-2007-096006 filed on Apr. 2, 2007, the content of which is hereby incorporated by reference into this application

### BACKGROUND OF THE INVENTION

1. Field of the Invention

The present invention relates to a method of controlling a communication path between a client's virtual machine and a server's virtual machine which operate by taking advantage of control function of virtual infrastructure.

2. Description of the Related Art

Conventionally, a client and a server had been constructed in real machines respectively, and the communication path had been established between the real machines by using a real network. Moreover, in order to enhance reliability in the communication, such technologies as teaming for duplexing the communication path have been developed intensively and enthusiastically. At present, a virtual machine can be set up on a real machine by taking advantage of the control technology of virtual infrastructure. Furthermore, it has become possible to construct clients and servers by setting up an infrastructure including a plurality of virtual machines on one and the same real machine.

Also, in order to reproduce the real machine infrastructure with a high fidelity in the control function of virtual infrastructure, there exist such technologies as virtual device technology and virtual network technology. Thanks to these technologies, it is getting more and more possible to operate a virtual machine such that basically the same processing as the one by the real server will be executed in the virtual server.

The communication between the virtual machines in one and the same real machine is performed via a virtual network which is configured using software. In this virtual network, there exists none of hardware about the network control, communication cables for transmitting electrical signals, and contact nodes to which the cables are to be connected. Instead, the communication is performed by taking advantage of a shared memory partition in which read/write can be performed from both sides of a transmission source and a transmission destination. In this way, the communication traffic is also controlled and managed using the software.

In association with the above-described technologies, at this present point-in-time, i.e., Mar. 30, 2007, “Scale Up Network Availability and Performance with Multi-port Gigabit Adapters” issued at http://www.intel.com/network/connectivity/resources/doc_library/tech_brief/maximizing_gig.pdf, and “Improving IT Management with Multi-Port NICs and Virtual Infrastructure” issued at http://www.intel.com/network/connectivity/resources/doc_library/white_papers/intel_vmware_wp.pdf are known as the prior-art technical documents.

### SUMMARY OF THE INVENTION

Taking advantage of the control function of virtual infrastructure has made it possible to construct a virtual machine. This accomplishment has allowed a large number of virtual machines to be constructed on a real machine. Also, thanks to the control function of virtual infrastructure, it has become possible to transfer a virtual machine to another real machine which is executing the control function of virtual infrastructure, and to operate the same virtual machine on another real machine. However, the network configuration before the displacement and the one after the displacement are so designed as to be reconstructed with a high fidelity. Accordingly, the communication path is fixed. Namely, no accomplishment is made regarding the implementation of reliability and CPU-load reduction by dynamically changing the communication path through consideration of position relationship between the communication-destination virtual machine and the communication-source virtual machine.

Also, in recent years, in accompaniment with the system construction in which practical utilization of the control function of virtual infrastructure is taken into the field-of-view, there has appeared a request for asking for a reduction in CPU usage ratio by the software for processing the virtual network. The virtual network is now being developed intensively and enthusiastically as the technology for reproducing the real network by information transfer using the memory. In the virtual network, however, no accomplishment is made regarding the control over the communication path in which consideration is given to the communication reliability and attention is paid to the existence of the communication-destination virtual server.

It is an object of the present invention to provide a technology for implementing a reduction in the CPU usage ratio in the network processing between operating virtual machines, and for dynamically controlling the multiplicity degree of a multiplexed communication path.

Also, it is another object of the present invention to ensure reliability for preventing such phenomena as loss of information on the communication path, including a physical communication path.

Incidentally, in the present invention, the multiplicity degree refers to the number of paths of the multiplexed communication path. The multiplexed communication path refers to a communication path which includes at least two or more communication paths.

In the present invention, in order to solve at least one of the above-described problems, there is provided a technology for recording pair information into a reference-capable shared memory partition from both a virtual machine and the control function of virtual infrastructure. Here, the pair information indicates a correspondence relationship between the virtual machine and a real machine on which the virtual machine operates.

Also, in the present invention, in order to solve at least one of the above-described problems, there is provided a technology for making a judgment, from the above-described recorded pair information, as to whether or not a communication-destination virtual machine exists on the same real machine as that of a communication-source virtual machine, and a technology for changing the multiplicity degree in accordance with this judgment.

Also, in the present invention, in order to solve at least one of the above-described problems, there is provided a technology for rewriting the above-described recorded pair information when the virtual machine has displaced to another real machine.

For example, in the present invention, a virtual machine-real machine pair information table is provided within a memory of a real machine. When an application operating in a virtual machine within the real machine makes a communication request, the application makes the communication request to a multiplicity-degree control function existing in the virtual machine. The multiplicity-degree control function makes reference to the virtual machine-real machine pair information table, thereby making the judgment as to whether or not a communication-destination virtual machine exists on the same real machine as that of the communication-source virtual machine. If the communication-destination virtual machine exists on the same real machine, the multiplicity degree of the multiplexed communication path is lowered, thereby reducing the CPU usage ratio of the real machine needed for the network processing.

Also, when the virtual machine has displaced to another real machine, a control processing unit of virtual infrastructure existing in the real machine of the virtual-machine displacement source rewrites the virtual machine-real machine pair information table. Simultaneously, the control processing unit of virtual infrastructure makes an update request for the virtual machine-real machine pair information table to at least a control function of virtual infrastructure existing in the real machine of the virtual-machine displacement destination. Having received the update request, a control processing unit of virtual infrastructure of the virtual-machine transfer destination rewrites the above-described table. Using the above-described method, solution of the problems is performed dynamically.

According to the present invention, it becomes possible to ensure the communication reliability, and to reduce the CPU usage ratio used for the network processing.

Also, according to the present invention, it becomes possible to prevent such phenomena as loss of information, thereby allowing accomplishment of the ensuring of the reliability.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of a communication-path control system 600;

FIG. 2 is a schematic diagram for illustrating initial values 300 of a virtual machine-real machine pair information table;

FIG. 3 is a flowchart for illustrating activation operation of the communication-path control system 600;

FIG. 4 is a flowchart for illustrating activation operation of a control processing unit 140 of virtual infrastructure in a real machine 100;

FIG. 5 is a flowchart for illustrating multiplicity-degree control of a multiplicity-degree control unit 122A in the real machine 100;

FIG. 6 is a schematic diagram for illustrating virtual machine-real machine pair information tables 131 and 231 before logical partition 120B for a virtual machine has been displaced from the real machine 100 to a real machine 200 in a case where a virtual machine will be displaced between the real machines;

FIG. 7 is a schematic diagram for illustrating the virtual machine-real machine pair information tables 131 and 231 after the logical partition 120B for virtual machine has been displaced from the real machine 100 to the real machine 200 in the case where the virtual machine will be displaced between the real machines;

FIG. 8 is a flowchart for illustrating operation of the communication-path control system 600 when the logical partition 120B for virtual machine is displaced from the real machine 100 to the real machine 200 in the case where the virtual machine will be displaced between the real machines;

FIG. 9 is a schematic diagram of the communication-path control system 600 in which the communication path between the real machines is uniplexed;

FIG. 10 is a schematic diagram for illustrating the virtual machine-real machine pair information tables 300 and 131 before a rewriting unit 144 of virtual machine-real machine pair information table rewrites the tables 300 and 131;

FIG. 11 is a schematic diagram for illustrating the virtual machine-real machine pair information table 131 after the rewriting unit 144 of virtual machine-real machine pair information table has written the table 131;

FIG. 12 is a flowchart for illustrating the activation operation of the control processing unit 140 of virtual infrastructure in the real machine 100 when the communication path between the real machines is uniplexed; and

FIG. 13 is a flowchart for illustrating operation of the control processing unit 140 of virtual infrastructure when a path between a communication interface 160 held by the real machine 100 and a communication interface 250 held by the real machine 200 is disconnected.

### DESCRIPTION OF THE EMBODIMENTS

Hereinafter, referring to the drawings, the explanation will be given below concerning the present invention.

Incidentally, in the following embodiments, configuration components, which have the same structures and to which the same reference numerals are affixed, perform the same operations in principle. Accordingly, the overlapped explanation will be omitted below.

### 1st Embodiment

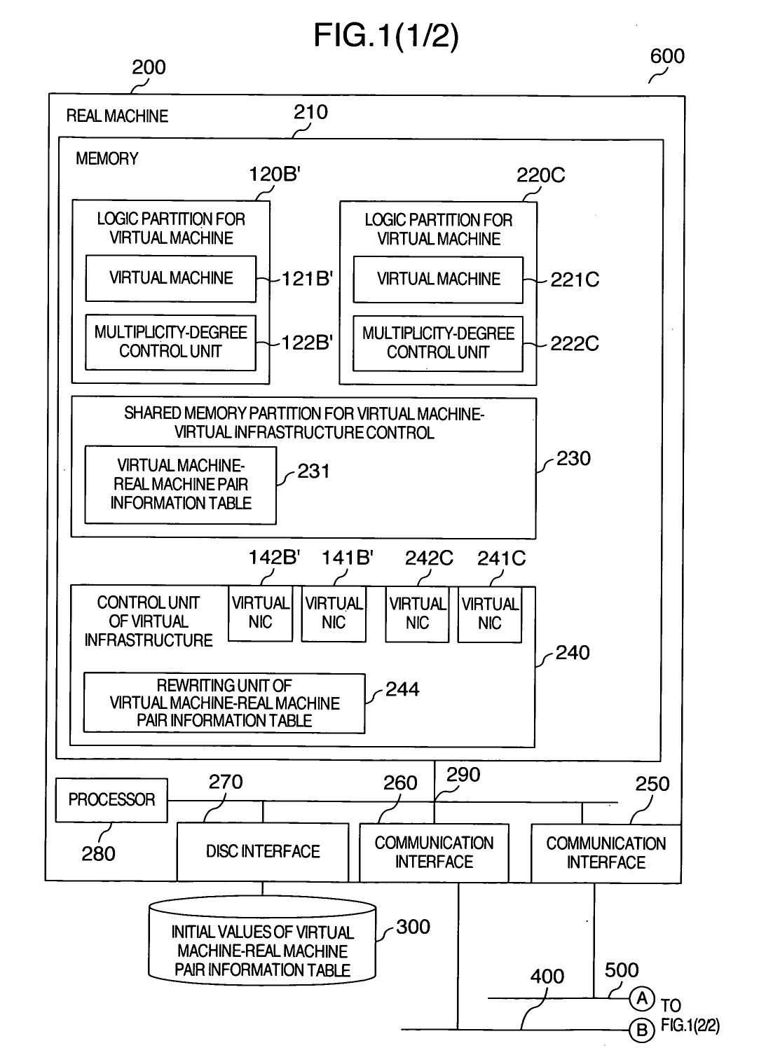

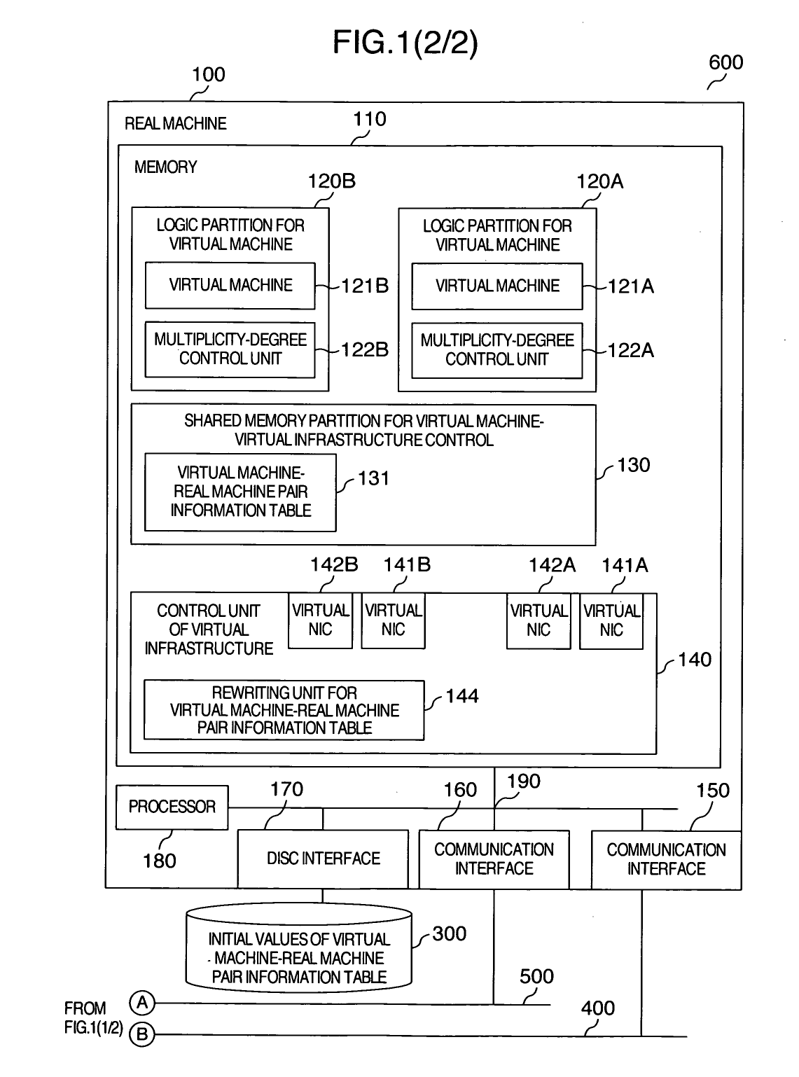

Hereinafter, referring to FIG. 1 through FIG. 5, the explanation will be given below concerning a first embodiment.

FIG. 1 is a configuration of the present embodiment. A communication-path control system 600 includes a first real machine 100 and a second real machine 200. These real machines are connected via LANs 400 and 500, and implement duplexed multiplicity degree.

The first real machine 100 is a configuration example of the real machine which operates a virtual machine. The first real machine 100 includes a processor 180, a memory 110, communication interfaces 150 and 160, and a disc interface 170. These devices are connected via a communication path 190. Here, a bus will be used for the explanation concretely.

The first real machine 100 has, outside the machine, a disc 300 which records initial values of virtual machine-real machine pair information table. Also, network cables 400 and 500 used for the multiplexing are connected to the communication interfaces 150 and 160, and are connected to the other real machine 200 based on the duplexed configuration.

In the memory 110 of the first real machine 100, there exist a control unit 140 of virtual infrastructure needed for operating a virtual machine, a rewrite processing unit 144 of virtual machine-real machine pair information table, virtual NICs (Network Interface Cards) 141A and 142A used for a multiplicity-degree control unit 122A, virtual NICs 141B and 142B used for a multiplicity-degree control unit 122B, and a shared memory partition 130 for control of virtual machine-virtual infrastructure.

In a logical partition 120A for virtual machine, there exists the multiplicity-degree control unit 122A. In a logical partition 120B for virtual machine, there exists a multiplicity-degree control unit 122B as a second virtual machine. The respective processings by the multiplicity-degree control units 122A and 122B, the rewrite processing unit 144 of virtual machine-real machine pair information table, and the control unit 140 of virtual infrastructure are performed by executing controls by these control units with the use of the processor 180.

The shared memory partition 130 for control of virtual machine-virtual infrastructure stores therein a virtual machine-real machine pair information table 131 for indicating a correspondence relationship as to which of the virtual machines exists on which of the real machines. On the present table, the correspondence relationship is indicated by each item in FIG. 1, which will be described later.

The respective processings by the virtual machines 121A and 121B, the control unit 140 of virtual infrastructure, the rewrite processing unit 144 of virtual machine-real machine pair information table, the virtual NICs 141A and 142A used for the multiplicity-degree control unit 122A, the virtual NICs 141B and 142B used for the multiplicity-degree control unit 122B, and the multiplicity-degree control units 122A and 122B, which are stored into the memory of the first real machine 100, can be implemented by being executed by the processor 180. These processing units, however, can also be implemented as hardware by being formed into integrated circuits or the like as the processing units for performing the respective processings.

Hereinafter, for simplicity of the explanation, with respect to the first real machine, the processings by each control unit and processing unit are implemented by programs expanded on the memory. Each processing unit, which is implemented by the processor 180's executing each program, will be explained below as the principal operation component for each processing.

The structure of the second real machine is basically the same as the one of the first real machine. Consequently, the explanation thereof will be omitted here.

Incidentally, although a logical partition 120B′ for virtualmachine and virtual NICs 141B′ and 142B′ are described on the second real machine, these components will not be used in the present embodiment.

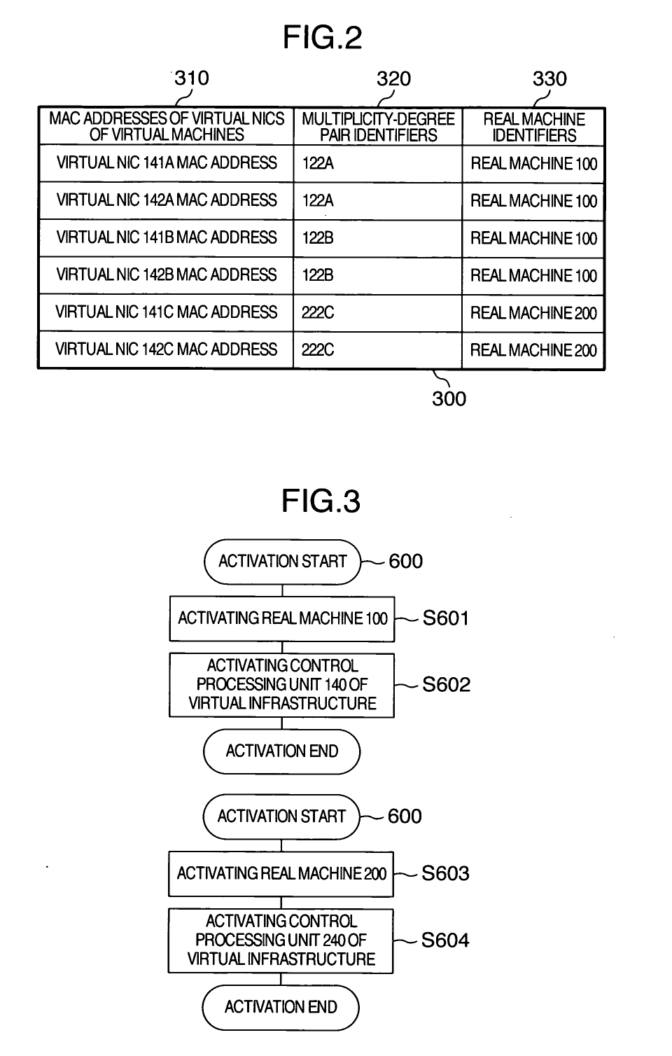

FIG. 2 is an example of the diagram for illustrating the initial values 300 of virtual machine-real machine pair information table.

The initial values 300 are initial information to be read into the virtual machine-real machine pair information tables 131 and 231. The table stores therein, as virtual-machine information, MAC addresses 310 of the virtual NICs of the virtual machines, multiplicity-degree pair identifiers 320 for identifying a virtual NIC in the case where a virtual machine changes the multiplicity degree of a communication path, and real machine identifiers 330, i.e., identifiers for allowing the real machines such as machine names to be identified uniquely within the system. Also, this pair information may also be expressed by a correspondence relationship between IP addresses allocated to the virtual machines and the real machine identifiers.

FIG. 3 is an example of the diagram for illustrating an activation operation flow of the communication-path control system 600, which is a configuration of the present embodiment. The communication-path control system 600 activates the communication-path multiplexing control system by performing an activation of the control unit 140 of virtual infrastructure (step 602) after an activation of the real machine 100 (step 601), and an activation of the control unit 240 of virtual infrastructure (step 604) after an activation of the real machine 200 (step 603).

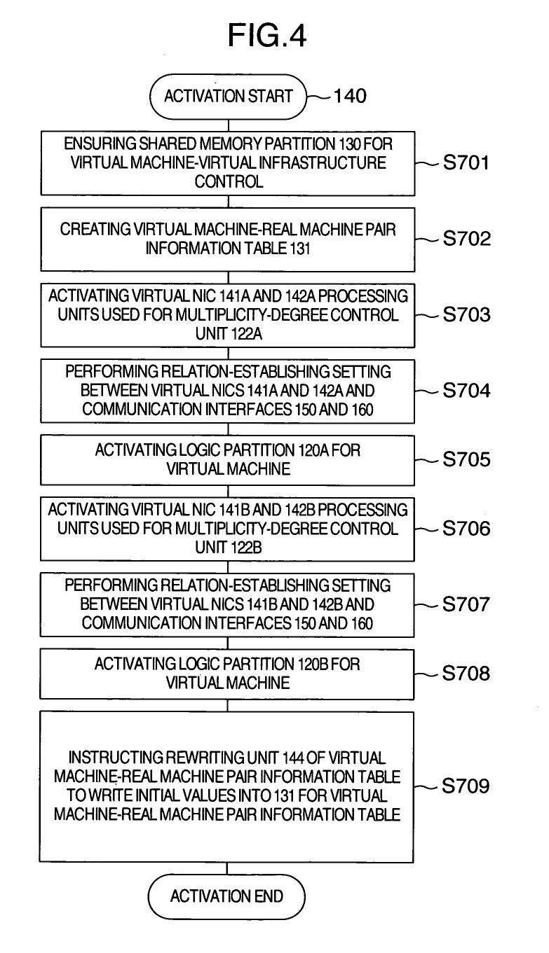

FIG. 4 is an example of the diagram for illustrating an activation operation flow of the control processing unit 140 of virtual infrastructure in the real machine 100.

The control processing unit 140 of virtual infrastructure ensures the shared memory partition 130 for control of virtual machine-virtual infrastructure on the memory 110 (step 701).

The control processing unit 140 of virtual infrastructure creates the virtual machine-real machine pair information table 131 (step 702).

As an in-advance preparation for boot-up of the first virtual machine 121A, the control processing unit 140 of virtual infrastructure activates the virtual NIC 141A and 142A processing units used for the multiplicity-degree control unit 122A (step 703). The control processing unit 140 of virtual infrastructure performs a relation-establishing setting between the virtual NIC 141A processing unit and the communication interface 150, and a relation-establishing setting between the virtual NIC 142A processing unit and the communication interface 160, thereby setting the multiplicity degrees of the communication paths to the LAN 400 and the LAN 500 (step 704). The control processing unit 140 of virtual infrastructure activates the logical partition 120A for virtual machine (step 705).

As an in-advance preparation for boot-up of the second virtual machine 121B, the control processing unit 140 of virtual infrastructure activates the virtual NIC 141B and 142B processing units used for the multiplicity-degree control unit 122B (step 706). The control processing unit 140 of virtual infrastructure performs a relation-establishing setting between the virtual NIC 141B processing unit and the communication interface 150, and a relation-establishing setting between the virtual NIC 142B processing unit and the communication interface 160, thereby setting the multiplicity degrees of the communication paths to the LAN 400 and the LAN 500 (step 707). The control processing unit 140 of virtual infrastructure activates the logical partition 120B for virtual machine (step 708).

The control processing unit 140 of virtual infrastructure instructs the rewriting unit 144 of virtual machine-real machine pair information table to write the initial values of virtual machine-real machine pair information table into the virtual machine-real machine pair information table 131 (step 709).

The activation of the real machine 200 is basically the same as the one of the real machine 100. Consequently, the explanation thereof will be omitted here.

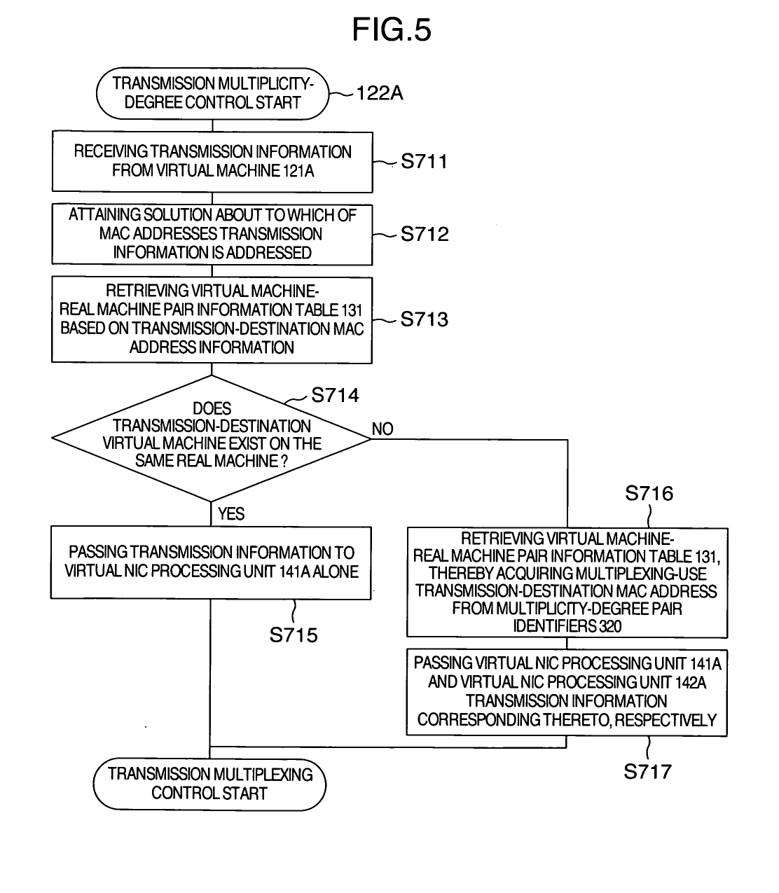

FIG. 5 is a multiplicity-degree control flow by the multiplicity-degree control unit 122A in the real machine 100. The multiplicity-degree control processing unit 122A is in charge of the multiplexing in the Data Link Layer.

The multiplicity-degree control processing unit 122A receives a transmission information from the virtual machine 121A (step 711). The multiplicity-degree control processing unit 122A attains a solution about to which of the MAC addresses the transmission information is addressed (step 712). Based on the transmission-destination MAC address information, the multiplicity-degree control processing unit 122A retrieves the virtual machine-real machine pair information table 131 (step 713). The multiplicity-degree control processing unit 122A judges whether or not the transmission-destination virtual machine exists on the same real machine 100 (step 714). If the transmission-destination virtual machine exists on the same real machine 100, the multiplicity-degree control processing unit 122A passes the transmission information to the virtual NIC processing unit 141A alone (step 715). Meanwhile, if the transmission-destination virtual machine does not exist on the same real machine 100, the multiplicity-degree control processing unit 122A retrieves the virtual machine-real machine pair information table 131, thereby acquiring a destination MAC address for multiplicity from the multiplicity-degree pair identifiers 320 (step 716). Then, the unit 122A passes the virtual NIC processing unit 141A and the virtual NIC processing unit 142A the transmission information corresponding thereto, respectively (step 717).

This multiplicity-degree control is not influenced by the protocols higher than the Data Link Layer. Accordingly, the explanation regarding the higher-order protocols will be omitted here.

Based on the foregoing configuration, the communication between the virtual machines executed on one and the same real machine can be carried out based on the single path, and the communication between the virtual machines executed on the different real machines can be duplexed. This makes it possible to reduce a CPU overhead which accompanies the communication processing between the virtual machines within one and the same real machine, and also to ensure reliability in the communication processing between the virtual machines within another real machine.

### 2nd Embodiment

Hereinafter, referring to FIG. 1 and FIG. 6 through FIG. 8, the explanation will be given below concerning a second embodiment.

The present embodiment indicates the multiplexing of a communication path in a case where the logical partition 120B for virtual machine will be displaced from the real machine 100 to the real machine 200.

In FIG. 1, the logical partition 120B for virtualmachine, which has existed on the memory 110 of the real machine 100, will be displaced onto the memory 210 of the real machine 200 (i.e., the logical partition 120B′ for virtual machine). Also, the virtual NIC processing units 141B and 142B exist on the control unit 240 of virtual infrastructure as the identical processing units to the ones before the displacement from the real machine 100 (i.e., 141B′ and 142B′).

Incidentally, the logical partition 220C for virtual machine on the real machine 200 in FIG. 1 will not be used in the present embodiment.

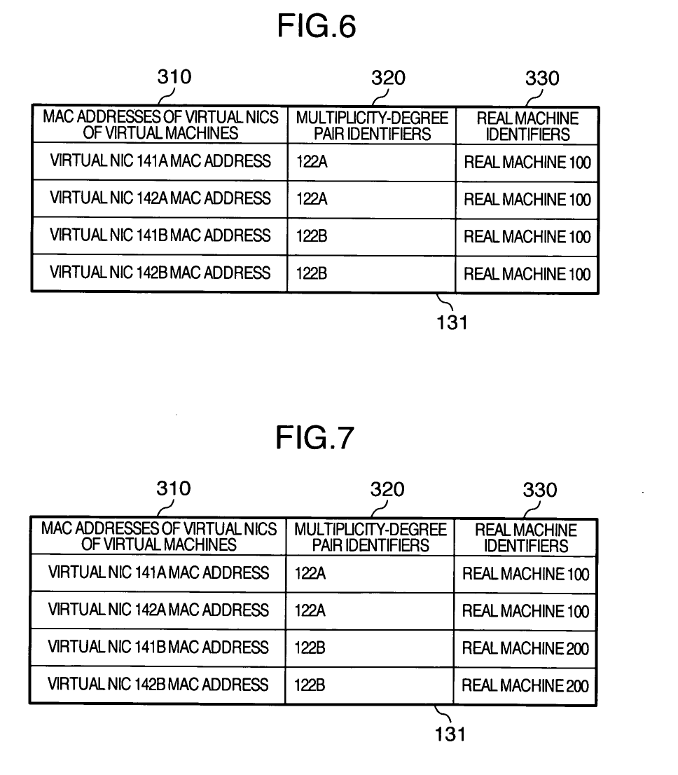

FIG. 6 is an example for illustrating the virtual machine-real machine pair information tables 131 and 231 before the logical partition 120B for virtual machine has been displaced from the real machine 100 to the real machine 200 in the case where the virtual machine in the second embodiment will be displaced between the real machines.

FIG. 7 is an example for illustrating the virtual machine-real machine pair information tables 131 and 231 after the logical partition 120B for virtual machine has been displaced from the real machine 100 to the real machine 200 in the case where the virtual machine in the second embodiment will be displaced between the real machines.

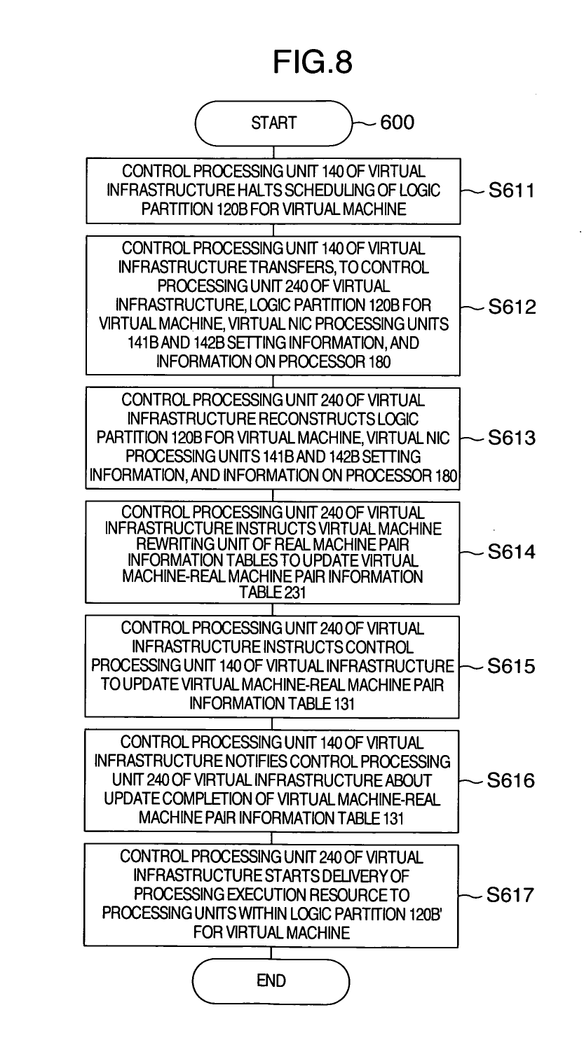

FIG. 8 is an operation flow of the communication-path control system 600 when the logical partition 120B for virtual machine is displaced from the real machine 100 to the real machine 200 in the case where the virtual machine in the second embodiment will be displaced between the real machines.

When the virtual machine is displaced, the control processing unit 140 of virtual infrastructure halts scheduling of the logical partition 120B for virtual machine (step 611). The control processing unit 140 of virtual infrastructure transfers, to the control processing unit 240 of virtual infrastructure, the logical partition 120B for virtual machine, the virtual NIC processing units 141B and 142B setting information, and information on the processor 180 (step 612). Based on the information transferred, the control processing unit 240 of virtual infrastructure reconstructs the logical partition 120B for virtual machine, the virtual NIC processing units 141B and 142B setting information, and the information on the processor 180 (step 613). The control processing unit 240 of virtual infrastructure instructs the rewriting unit 244 of virtual machine-real machine pair information table to update the virtual machine-real machine pair information table 231 in accordance with the contents received (step 614). After that, the control processing unit 240 of virtual infrastructure instructs the control processing unit 140 of virtual infrastructure to update the virtual machine-real machine pair information table 131 (step 615). The control processing unit 140 of virtual infrastructure notifies the control processing unit 240 of virtual infrastructure about update completion of the virtual machine-real machine pair information table 131 (step 616). The control processing unit 240 of virtual infrastructure starts scheduling within the logical partition 120B′ for virtual machine existing on the memory 210, then starting execution of the virtual machine (step 617).

The communication processing after the displacement completion is carried out in accordance with basically the same method as the one indicated in the first embodiment. Incidentally, in the foregoing invention, it is also allowable to employ the introduction method via medium such as program, or using communication unit such as network.

Based on the foregoing configuration, when the virtual machine is displaced, the virtual machine-real machine pair information tables are updated at the displacement source and the displacement destination of the virtual machine. This update allows the processing to be continued in the multiplicity degree of an appropriate communication path even when the virtual machine has been displaced between the real machines.

### 3rd Embodiment

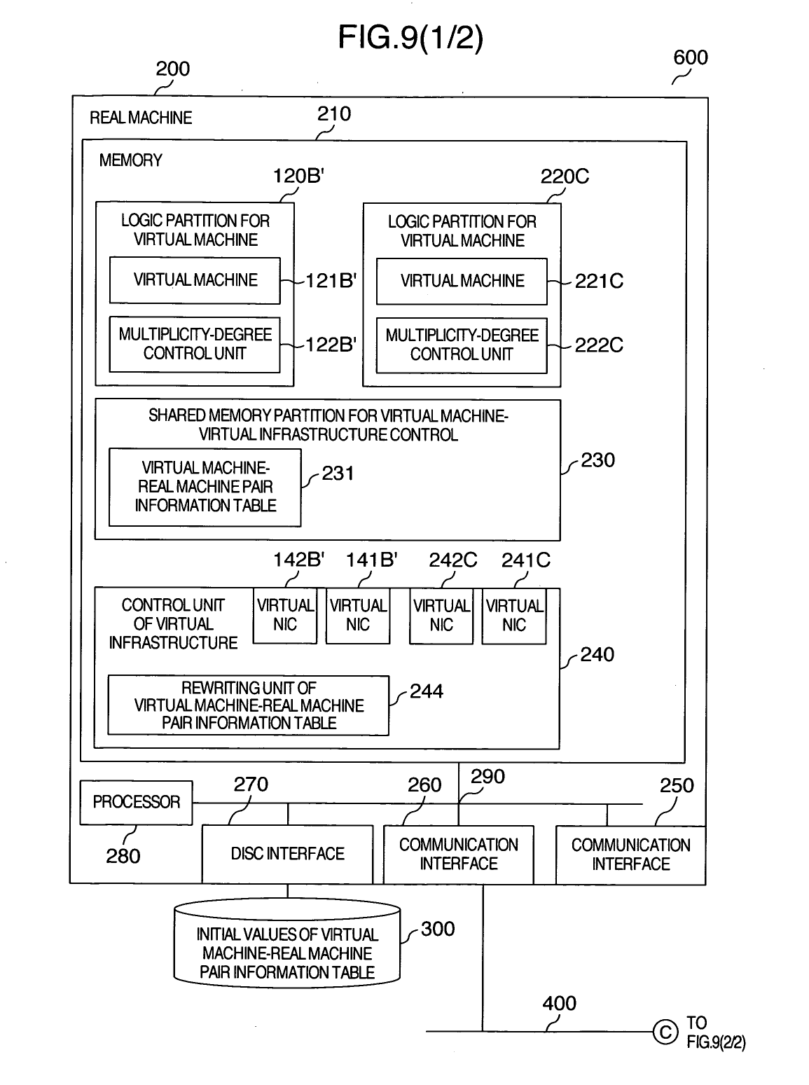

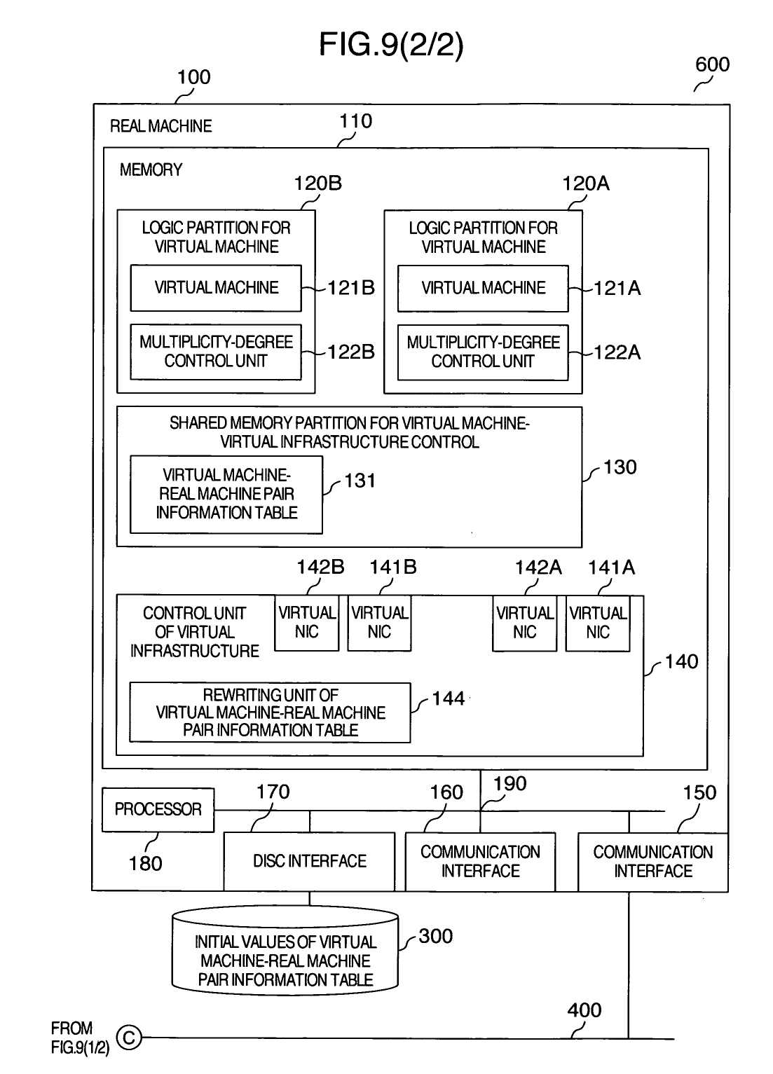

Hereinafter, referring to FIG. 9 through FIG. 13, the explanation will be given below concerning a third embodiment.

FIG. 9 is a configuration of the present embodiment. The communication-path control system 600 includes the first real machine 100 and the second real machine 200. These real machines are connected via a LAN 400, and implement uniplexed multiplicity degree.

The first real machine 100 is a configuration example of the real machine which operates a virtual machine. The first real machine 100 includes the processor 180, the memory 110, the communication interfaces 150 and 160, and the disc interface 170. These devices are connected via the communication path 190. Here, a bus will be used for the explanation concretely.

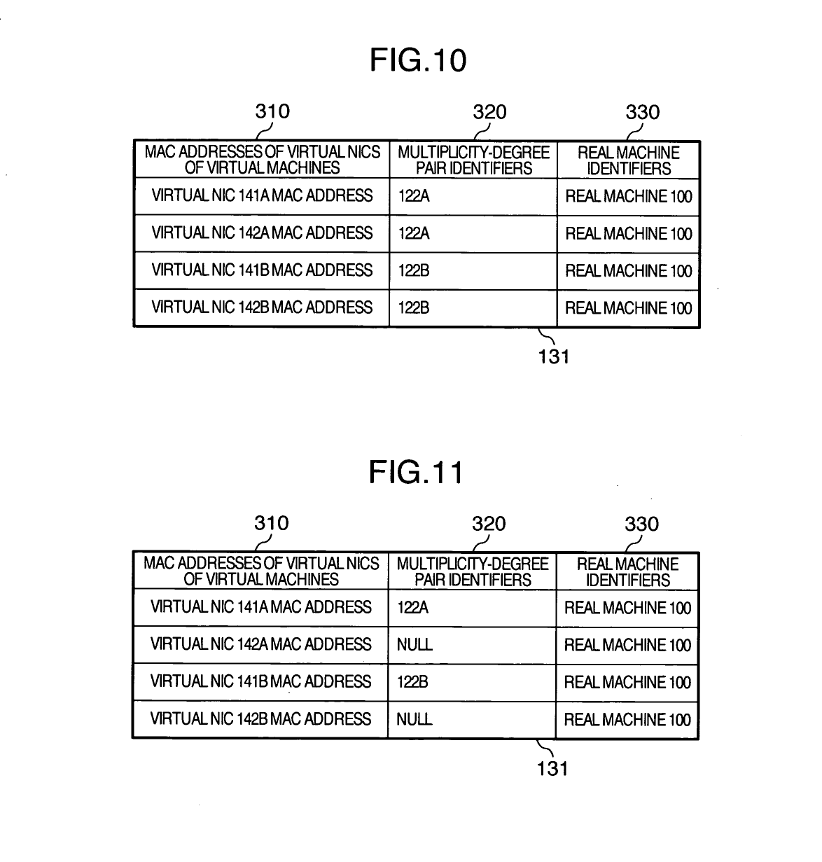

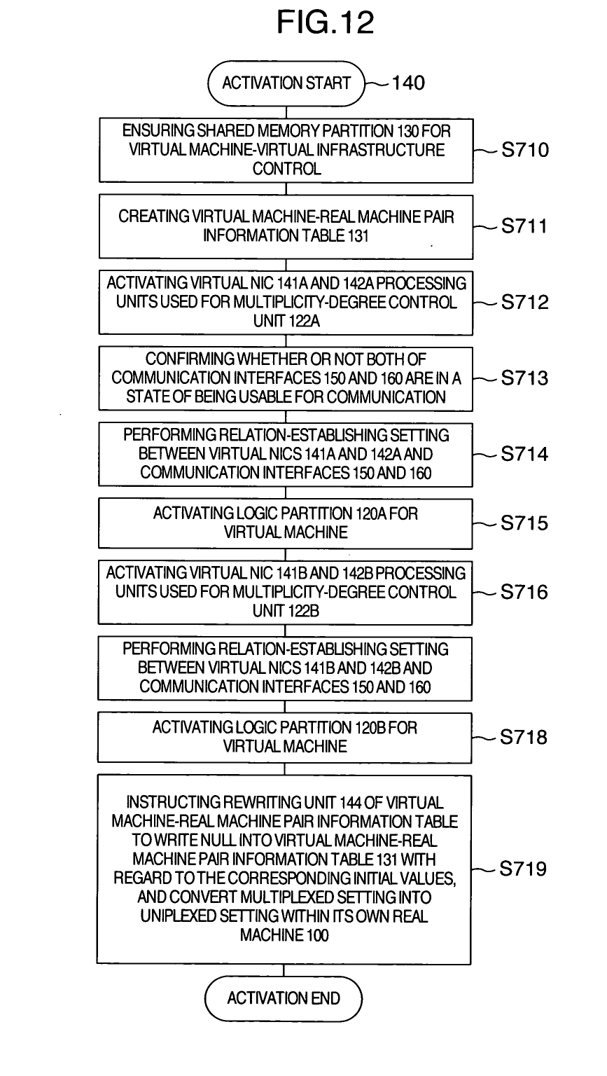

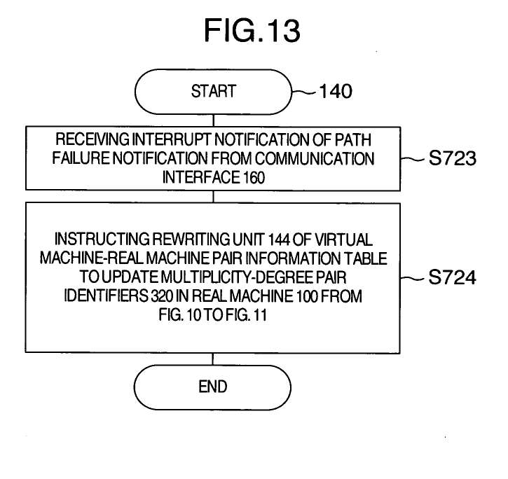

The first real machine 100 is connected in a communication-capable manner to the disc 300 which records initial values of virtual machine-real machine pair information table. On the present table, the correspondence relationship is indicated by each item in FIG. 10, which will be described later. Also, as the network cables used for the multiplexing, only the network cable 400 is connected to the communication interface 150, and is connected to the other real machine 200 based on the uniplexed configuration.

The first real machine 100 is equipped with the communication interfaces 150 and 160 which are usable for the multiplexing. Here, however, no network cable is connected to the communication interface 160. Accordingly, the communication interface 160 is regarded as not having an infrastructure needed for the multiplexing.

In the memory 110 of the first real machine 100, there exist the control unit 140 of virtual infrastructure needed for operating the virtual machine, the rewrite processing unit 144 of virtual machine-real machine pair information table, the virtual NICs (Network Interface Cards) 141A and 142A used for the multiplicity-degree control unit 122A, the virtual NICs 141B and 142B used for the multiplicity-degree control unit 122B, and the shared memory partition 130 for control of virtual machine-virtual infrastructure. The virtual NICs 141A and 142A may also be virtual communication interfaces which simulate communication interfaces other than the NICs.

In the logical partition 120A for virtual machine, there exists the multiplicity-degree control unit 122A. In the logical partition 120B for virtual machine including the second virtual machine, there exists the multiplicity-degree control unit 122B. The respective processings are performed by the processor 180's controlling these multiplicity-degree control units 122A and 122B, rewrite processing unit 144 of virtual machine-real machine pair information table, and control unit 140 of virtual infrastructure.

The shared memory partition 130 for control of virtual machine-virtual infrastructure stores therein the virtual machine-real machine pair information table 131 for indicating the correspondence relationship as to which of the virtual machines is operating on which of the real machines. On the present table, the correspondence relationship is indicated by each item in FIG. 11, which will be described later.

The respective processings by the virtual machines 121A and 121B, the control unit 140 of virtual infrastructure, the rewrite processing unit 144 of virtual machine-real machine pair information table, the virtual NICs 141A and 142A used for the multiplicity-degree control unit 122A, the virtual NICs 141B and 142B used for the multiplicity-degree control unit 122B, and the multiplicity-degree control units 122A and 122B, which are stored into the memory 110 of the first real machine 100, can be implemented by being executed by the processor 180. These processing units, however, can also be implemented as hardware by being formed into integrated circuits or the like as the processing units for performing the respective processings.

Hereinafter, for simplicity of the explanation, with respect to the first real machine, the processings by each control unit and processing unit are implemented by programs expanded on the memory. Each processing unit, which is implemented by the processor 180's executing each program, will be explained below as the principal operation component for each processing.

The structure of the second real machine is basically the same as the one of the first real machine. Consequently, the explanation thereof will be omitted here.

Incidentally, although the logical partition 120B′ for virtual machine and the virtual NICs 141B′ and 142B′ are described on the second real machine, these components will not be used in the present embodiment.

FIG. 10 is an example of the diagram for illustrating the initial values 300 of virtual machine-real machine pair information table.

The initial values 300 are initial information to be read into the virtual machine-real machine pair information tables 131 and 231. The initial values 300 store therein, as the virtual machine information, the MAC addresses 310 of the virtual NICs of the virtual machines, the multiplicity-degree pair identifiers 320 for identifying a virtual NIC in the case where a virtual machine changes the multiplicity degree of a communication path, and the real machine identifiers 320, i.e., identifiers for allowing the real machines such as machine names to be identified uniquely within the system. Also, the MAC addresses have been used in the present embodiment. This pair information, however, may also be expressed instead by some other addresses such as IP addresses allocated to the virtual machines.

Incidentally, here, the following assumption is made: The virtual NIC 141A is caused to correspond to the communication interface 150, the virtual NIC 142A is caused to correspond to the communication interface 160, and the multiplicity degree is indicated by the multiplicity-degree pair identifiers 320.

FIG. 11 is an example of the diagram for illustrating the virtual machine-real machine pair information table 131 after being rewritten from the initial values in the present embodiment.

FIG. 11 is the table expanded on the memory by the rewriting unit of virtual machine-real machine pair information table. The table stores therein, as the virtual machine information, the MAC addresses 310 of the virtual NICs of the virtual machines, the multiplicity-degree pair identifiers 320 for identifying a virtual NIC in the case where a virtual machine changes the multiplicity degree of a communication path, and the real machine identifiers 330, i.e., identifiers for allowing the real machines such as machine names to be identified uniquely within the system. Also, this pair information may also be expressed by the correspondence relationship between IP addresses allocated to the virtual machines and the real machine identifiers.

In FIG. 10 which illustrates the initial values, the virtual NIC 142A is caused to correspond to the communication interface 160, and the multiplicity-degree pair identifiers 320 are affixed. Here, however, the communication interface 160 is unusable in the communication-path multiplexing. Accordingly, NULL i.e., an identifier for indicating invalidity, is affixed as the multiplicity-degree pair identifier in FIG. 11.

The activation operation of the communication-path control system 600 is basically the same as the one illustrated in FIG. 3. Consequently, the explanation thereof will be omitted here.

FIG. 12 is an example of the diagram for illustrating the activation operation flow of the control processing unit 140 of virtual infrastructure in the real machine 100. The control processing unit 140 of virtual infrastructure ensures the shared memory partition 130 for control of virtual machine-virtual infrastructure on the memory 110 (step 710).

The control processing unit 140 of virtual infrastructure creates the virtual machine-real machine pair information table 131 (step 711).

As an in-advance preparation for boot-up of the first virtual machine 121A, the control processing unit 140 of virtual infrastructure activates the virtual NIC 141A and 142A processing units used for the multiplicity-degree control unit 122A (step 712), then confirming whether or not both of the communication interfaces 150 and 160 are in a state of being usable for the communication (step 713). The control processing unit 140 of virtual infrastructure performs the relation-establishing setting between the virtual NIC 141A processing unit and the communication interface 150, and the relation-establishing setting between the virtual NIC 142A processing unit and the communication interface 160, thereby setting the multiplicity degree of the communication path to the LAN 400 (step 714). Here, the control processing unit 140 of virtual infrastructure detects that the communication interface 160 is not connected to the network, and that it is incapable of performing the communication. The control processing unit 140 of virtual infrastructure activates the logical partition 120A for virtual machine (step 715).

As an in-advance preparation for boot-up of the second virtual machine 121B, the control processing unit 140 of virtual infrastructure activates the virtual NIC 141B and 142B processing units used for the multiplicity-degree control unit 122B (step 716). The control processing unit 140 of virtual infrastructure performs the relation-establishing setting between the virtual NIC 141B processing unit and the communication interface 150, and the relation-establishing setting between the virtual NIC 142B processing unit and the communication interface 160, thereby setting the multiplicity degree of the communication path to the LAN 400 (step 717). Here, the control processing unit 140 of virtual infrastructure detects that the communication interface 250 is not connected to the network, and that it is incapable of performing the communication. The control processing unit 140 of virtual infrastructure activates the logical partition 120B for virtual machine (step 718).

The control processing unit 140 of virtual infrastructure instructs the rewriting unit 144 of virtual machine-real machine pair information table to write NULL, i.e., the identifier for indicating invalidity, into the multiplicity-degree pair identifier of the virtual NIC 142A corresponding to the communication interface 160 within the virtual machine-real machine pair information table, thereby converting the multiplexed setting into the uniplexed setting within its own real machine 100 (step 719).

The activation of the real machine 200 is basically the same as the one of the real machine 100. Consequently, the explanation thereof will be omitted here.

In this case, even if the address of the information transmitted by the virtual machine 121A is a MAC address of the virtual computer 120B′ which operates on the different real machine 200, the multiplicity-degree control unit 122A addresses and transmits the information to the virtual NIC 141B alone. This is because the virtual NIC 142B does not possess the same multiplicity-degree pair identifier 122B as the one possessed by the virtual NIC 141B which corresponds to the above-described MAC address. Namely, the wasted multiplexing is not performed, which makes it possible to suppress a rise in the CPU overhead. In the present embodiment, each real machine, which has been used for the explanation, is the real machine where each virtual machine possesses the two virtual NICs and the two communication interfaces, and where the multiplicity degree can be set at two at the maximum. The present invention, however, may also be applied to a real machine where the multiplicity degree can be set at three or more. In this case, the multiplicity degree may be controlled by rewriting the virtual machine-real machine pair information table such that the multiplicity degree is lowered down to a state where the networks are unusable.

Based on the foregoing configuration, the communication between the virtual machines in an infrastructure where the physical network is a single path can be carried out based on the single path. This makes it possible to reduce the CPU overhead which accompanies the communication processing of the virtual machines. Incidentally, the foregoing configuration is not influenced by the protocols higher than the Data Link Layer. Accordingly, the explanation regarding the higher-order protocols has been omitted here.

### 4th Embodiment

Hereinafter, referring to FIG. 1, FIG. 9 through FIG. 11, and FIG. 13, the explanation will be given below concerning a fourth embodiment.

FIG. 1 is basically the same as the first embodiment. Consequently, the explanation thereof will be omitted here.

FIG. 9 illustrates a state where, of FIG. 1, the network cable 500 is incapable of performing the communication due to failures such as disconnection.

FIG. 10 is an example of the diagram for illustrating the virtual machine-real machine pair information table 131 before the network cable 500 is disconnected.

FIG. 10 indicates initial information to be read into the virtual machine-real machine pair information tables 131 and 231. The table stores therein, as the virtual machine information, the MAC addresses 310 of the virtual NICs of the virtual machines, the multiplicity-degree pair identifiers 320 for identifying a virtual NIC in the case where a virtual machine changes the multiplicity degree of a communication path, and the real machine identifiers 330, i.e., identifiers for allowing the real machines such as machine names to be identified uniquely within the system. Also, this pair information may also be expressed by a correspondence relationship between IP addresses allocated to the virtual machines and the real machine identifiers.

The following assumption is made: The virtual NIC 141A is caused to correspond to the communication interface 150, the virtual NIC 142A is caused to correspond to the communication interface 160, and the multiplicity degree is indicated by the multiplicity-degree pair identifiers 320.

FIG. 11 is an example of the diagram for illustrating the virtual machine-real machine pair information table 131 which is rewritten by the rewriting unit of virtual machine-real machine pair information table since the network cable 500 has been disconnected.

FIG. 13 is an example of the diagram for illustrating the operation flow of the control processing unit 140 of virtual infrastructure at the time when the network cable 500 is disconnected in the real machine 100. The control processing unit 140 of virtual infrastructure receives an interrupt notification of the path failure notification from the communication interface 160 (step 723). Then, the unit 140 instructs the rewriting unit of virtual machine-real machine pair information table to update the multiplicity-degree pair identifiers 320 in the real machine 100 from FIG. 10 to FIG. 11, thereby performing the uniplexing (step 724).

Based on the foregoing configuration, when the physical networks become a single path due to a failure, the communication between the virtual machines can be carried out based on the single path. This makes it possible to reduce the CPU overhead which accompanies the communication processing of the virtual machines.

It should be further understood by those skilled in the art that although the foregoing description has been made on embodiments of the invention, the invention is not limited thereto and various changes and modifications may be made without departing from the spirit of the invention and the scope of the appended claims.

1. A computer system, comprising:
a plurality of physical computers connected to each other via a network; and
a plurality of virtual computers operating on said plurality of physical computers; wherein
said computer system further comprises:
virtual computer-physical computer pair information which memorizes addresses of said virtual computers, multiplicity-degree pair identifiers for indicating multiplicity degrees of said addresses, and identifiers of said physical computers on which said virtual computers are operating; and
a multiplicity-degree control unit for controlling multiplicity degree of a communication between said virtual computers based on said virtual computer-physical computer pair information and transmission information transmitted from said virtual computers.

2. The computer system according to claim 1, wherein
said multiplicity-degree control unit judges, based on said virtual computer-physical computer pair information, whether or not a transmission-destination virtual computer is operating on one and the same physical computer as that of said transmission-source virtual computer, said transmission-destination virtual computer being described in said transmission information transmitted from said transmission-source virtual computer,
said multiplicity-degree control unit transmitting said transmission information without multiplexing transmission, if said transmission-source and transmission-destination virtual computers are operating on said one and the same physical computer,
said multiplicity-degree control unit transmitting said transmission information with multiplexed transmission, if said transmission-source and transmission-destination virtual computers are operating on different physical computers.

3. The computer system according to claim 1, wherein
said virtual computers possess said plurality of addresses, respectively,
the same multiplicity-degree pair identifier being caused to correspond to an address with respect to said same virtual computer in said virtual computer-physical computer pair information,
said multiplicity-degree control unit transmitting said transmission information only to an address indicated by said transmission information, if transmission-source and transmission-destination virtual computers are operating on one and the same physical computer,
said multiplicity-degree control unit transmitting said transmission information to the address indicated by said transmission information and an address caused to correspond to said same multiplicity-degree pair identifier as that of said address indicated by said transmission information, if said transmission-source and transmission-destination virtual computers are operating on different physical computers.

4. The computer system according to claim 1, further comprising:
a rewriting unit of virtual computer-physical computer pair information for rewriting said virtual computer-physical computer pair information,
said rewriting unit of virtual computer-physical computer pair information rewriting said virtual computer-physical computer pair information when said virtual computer is displaced from said physical computer to another physical computer,
said multiplicity-degree control unit controlling said multiplicity degree of said communication between said virtual computers based on said rewritten virtual computer-physical computer pair information.

5. The computer system according to claim 1, further comprising:
a control processing unit of virtualized infrastructure for investigating number of communication paths available between said virtual computers,
said rewriting unit of virtual computer-physical computer pair information, based on the investigation, rewriting said multiplicity-degree pair identifiers in said virtual computer-physical computer pair information,
said multiplicity-degree control unit controlling said multiplicity degree of said communication between said virtual computers based on said rewritten virtual computer-physical computer pair information.

6. A communication control method of controlling a communication between a plurality of virtual computers, said virtual computers operating on a plurality of physical computers connected to each other via a network, wherein
a multiplicity-degree control unit comprising:
a judgment step of judging a transmission-destination virtual computer from transmission information transmitted from any of said virtual computers; and
a multiplicity-degree control step of controlling multiplicity degree of said communication in correspondence with said transmission-destination virtual computer by making reference to virtual computer-physical computer pair information which memorizes addresses of said virtual computers, multiplicity-degree pair identifiers for indicating said multiplicity degrees of said addresses, and identifiers of said physical computers on which said virtual computers are operating.

7. The communication control method according to claim 6, wherein,
at said multiplicity-degree control step,
said multiplicity-degree control unit judges, based on said virtual computer-physical computer pair information, whether or not said transmission-destination virtual computer is operating on one and the same physical computer as that of said transmission-source virtual computer,
said multiplicity-degree control unit transmitting said transmission information without multiplexing transmission, if said transmission-source and transmission-destination virtual computers are operating on said one and the same physical computer,
said multiplicity-degree control unit transmitting said transmission information with multiplexed transmission, if said transmission-source and transmission-destination virtual computers are operating on different physical computers.

8. The communication control method according to claim 6, wherein
said virtual computers possess said plurality of addresses, respectively,
the same multiplicity-degree pair identifier being caused to correspond to an address with respect to said same virtual computer in said virtual computer-physical computer pair information,
at said multiplicity-degree control step,
said multiplicity-degree control unit transmitting said transmission information only to an address indicated by said transmission information, if transmission-source and transmission-destination virtual computers are operating on one and the same physical computer,
said multiplicity-degree control unit transmitting said transmission information to the address indicated by said transmission information and an address caused to correspond to said same multiplicity-degree pair identifier as that of said address indicated by said transmission information, if said transmission-source and transmission-destination virtual computers are operating on different physical computers.

9. The communication control method according to claim 6, wherein
a rewriting unit of virtual computer-physical computer pair information comprises:
a rewriting step of rewriting said virtual computer-physical computer pair information when said virtual computer is displaced from said physical computer to another physical computer,
at said multiplicity-degree control step,
said multiplicity-degree control unit controlling said multiplicity degree of said communication between said virtual computers based on said rewritten virtual computer-physical computer pair information.

10. The communication control method according to claim 6, wherein
a control processing unit of virtualized infrastructure performs a communication-path investigation step of investigating number of communication paths available between said virtual computers;
said rewriting unit of virtual computer-physical computer pair information performing a rewriting step of rewriting said multiplicity-degree pair identifiers of said virtual computer-physical computer pair information in correspondence with the investigated number of said communication paths available;
at said multiplicity-degree control step,
said multiplicity-degree control unit controlling said multiplicity degree of said communication between said virtual computers based on said rewritten virtual computer-physical computer pair information.

11. A computer system, comprising:
a plurality of physical computers connected to each other via a network; and
a plurality of virtual computers operating on said plurality of physical computers; wherein
said computer system further comprises:
virtual computer-physical computer pair information which memorizes identifiers of said virtual computers, and identifiers of said physical computers on which said virtual computers are operating; and
a multiplicity-degree control unit for controlling multiplicity degree of a communication between said virtual computers based on said virtual computer-physical computer pair information and transmission information transmitted from said virtual computers.
